(19) United States
(12) Patent Application Publication
(10) Pub. No.: US 2010/0214308 A1
(43) Pub. Date: Aug. 26, 2010

(54) INFORMATION PROCESSING APPARATUS, INFORMATION PROCESSING METHOD AND COMPUTER-READABLE MEDIUM

(75) Inventor: Shinji Shishido, Tokyo (JP)

Correspondence Address: KIMBLE INTELLECTUAL PROPERTY LAW, PLLC, 1701 PENNSYLVANIA AVE., NW, SUITE 300, WASHINGTON, DC, 20006, US

(73) Assignee: Fuji Xerox Co., Ltd., Tokyo (JP)

(21) Appl. No.: 12/559,481

(22) Filed: Sep. 14, 2009

(30) Foreign Application Priority Data
Feb. 24, 2009 (JP) 2009-041041

(51) Int. Cl. G09G 5/02

(52) U.S. Cl. 345/589

(57) ABSTRACT

An information processing apparatus includes an acquiring unit, a selection unit, an extraction unit and a reconfiguration unit. The acquiring unit acquires a processing element group configured by successively connecting a plurality of processing elements for processing information, the information including a plurality of attributes. The selection unit selects, among the attributes, an attribute that allows a reduction in an information amount of the information when the attribute is modified. The extraction unit extracts, among the processing element group and processing elements that are functional equivalents of each of the processing elements, a processing element capable of processing the information of which the selected attribute is modified. The reconfiguration unit places an attribute modification element anterior to the extracted processing element to reconfigure the processing element group, the attribute modification element for modifying the selected attribute, the extracted processing element placed alone or in connected relation.

### CROSS-REFERENCE TO RELATED APPLICATIONS

This application is based on and claims priority under 35 USC 119 from Japanese Patent Application No. 2009-41041 filed on Feb. 24, 2009.

### BACKGROUND

### Technical Field

The invention relates to an information processing apparatus and an information processing method.

### SUMMARY

According to an aspect of the invention, an information processing apparatus includes an acquiring unit, a selection unit, an extraction unit and a reconfiguration unit. The acquiring unit acquires a processing element group configured by successively connecting a plurality of processing elements for processing information, the information including a plurality of attributes. The selection unit selects, among the attributes, an attribute that allows a reduction in an information amount of the information when the attribute is modified. The extraction unit extracts, among the processing element group and processing elements that are functional equivalents of each of the processing elements, a processing element capable of processing the information of which the selected attribute is modified. The reconfiguration unit places an attribute modification element anterior to the extracted processing element to reconfigure the processing element group, the attribute modification element for modifying the selected attribute, the extracted processing element placed alone or in connected relation.

### BRIEF DESCRIPTION OF THE DRAWINGS

Exemplary embodiments of the invention will be described in detail based on the following figures, wherein:

FIG. 1 is a functional block diagram of an example of an information processing apparatus according to the exemplary embodiment;

FIG. 2A is a view showing an example of a relation among an input image amount, an output image amount, and processing time of one processing module;

FIG. 2B is a view showing an example of a relation between the input image amount and the processing time of another processing module;

FIG. 2C is a view showing an example of a relation between the output image amount outputted from one processing module and a degree of image quality degradation;

FIG. 3 is a view showing an example of a pipeline in an initial state;

FIG. 4 is a view showing an example of a table in which attributes of image data and modification processing of the attributes are associated with each other;

FIG. 5A is an exemplary illustrative view related to a first method;

FIG. 5B is an exemplary illustrative view related to a second method;

FIG. 6A is a view showing an example of information on a relation between the input image amount and the processing time of a processing module B;

FIG. 6B is a view showing examples of relations among the input image amount, the output image amount, and the processing time of each of processing modules A1 and A2;

FIG. 6C is a view showing examples of relations between the output image amount and image quality;

FIG. 6D is a view showing an example of target processing times of each processing module;

FIG. 7 is a flow chart of an example of reconfiguration processing of the pipeline by the information processing apparatus; and

FIG. 8 is a view showing examples of processing time of each configuration of the pipeline.

### DETAILED DESCRIPTION

A description will be given below to an exemplary embodiment for carrying out the invention with reference to the drawings.

An information processing apparatus according to the exemplary embodiment of the invention has a function of reconfiguring a pipeline (processing element group) configured by successively connecting processing modules for processing image data (processing elements such as “enlargement”, “reduction”, “compression”, “color conversion”, and the like) so as to satisfy target costs (processing time, a resource such as a memory to be used, quality of outputted information, and the like). In the exemplary embodiment, processing for reconfiguring the pipeline is performed such that an output image outputted as the result of processing image data inputted to the pipeline has image quality equal to or higher than desired image quality, and the processing time of the pipeline is not more than desired time.

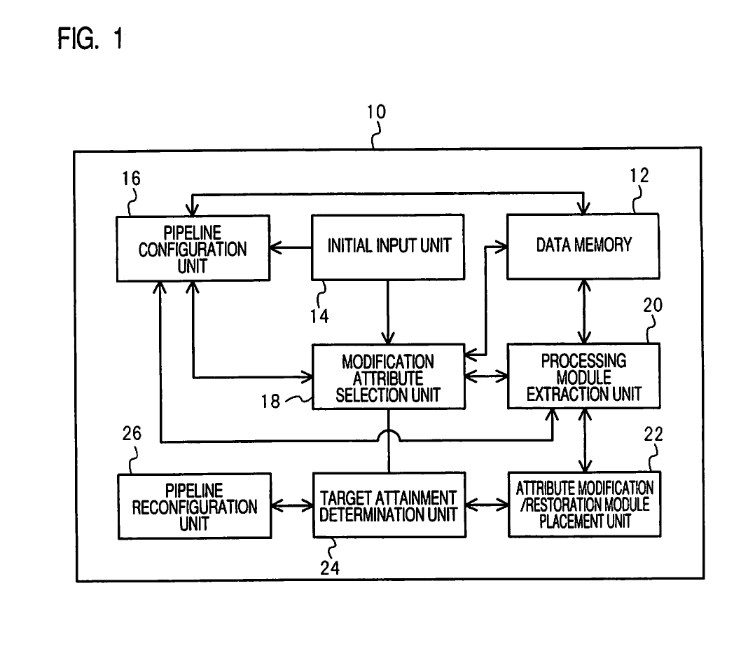

FIG. 1 shows a functional block diagram of an information processing apparatus 10 according to the exemplary embodiment. As shown in FIG. 1, the information processing apparatus 10 includes a data memory 12, an initial input unit 14, a pipeline configuration unit 16, a modification attribute selection unit 18, a processing module extraction unit 20, an attribute modification/restoration module placement unit 22, a target attainment determination unit 24, and a pipeline reconfiguration unit 26. The respective functions of the units described above may be implemented by causing a computer having a controller such as a CPU or the like, a memory, an input/output unit that transmits and receives data to and from an external device, and the like to read and execute a program stored in a computer readable information storage medium. The program may be supplied to the information processing apparatus 10 serving as the computer using the information storage medium or may be supplied thereto via a data communication network such as the Internet or the like. A description will be given below to the details of the respective units provided in the information processing unit 10.

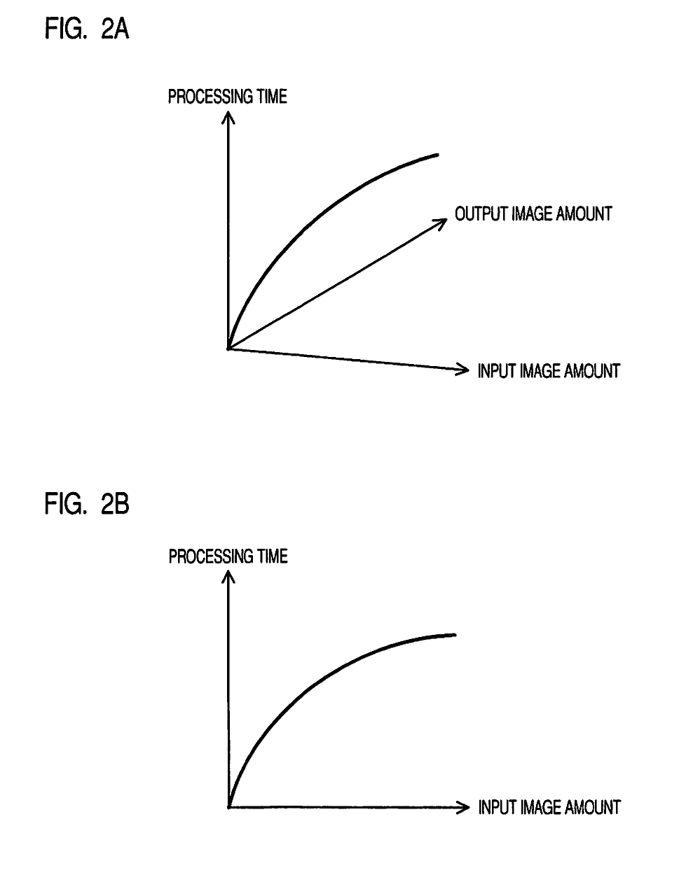

The data memory 12 includes a storage means such as a memory, a magnetic disk, or the like, and stores various data including data on each processing module constituting the pipeline, characteristic information on the processing time of each processing module exemplified in FIGS. 2A and 2B, and information on the relation between the image amount outputted from the processing module and the image quality exemplified in FIG. 2C.

FIG. 2A shows the relation among the input image amount, the output image amount, and the processing time of one processing module, while FIG. 2B shows the relation between the input image amount and the processing time of another processing module. As shown in FIGS. 2A and 2B, the processing time of the processing module is apt to increase as the input and/or output image amount increases.

In addition, FIG. 2C shows the relation between the output image amount outputted from one module and a degree of image quality degradation. As shown in FIG. 2C, the degree of image quality degradation is apt to increase as the output image amount from the processing module is reduced. These data items stored in the data memory 12 may be produced based on the results obtained by preliminarily performing the measurement of the processing time, sensory evaluation, and the like using a sample image.

The initial input unit 14 receives inputs of the image data to be processed, the content of the image processing, and cost targets (targets of the processing time, the output image quality, and the like) to be attained in the image processing.

The pipeline configuration unit 16 configures the pipeline in an initial state based on the image data and the content of the image processing received by the initial input unit 14. In this exemplary embodiment, the pipeline configuration unit 16 acquires the pipeline in the initial state by configuring the pipeline. The pipeline configuration unit 16 may be implemented by a known program.

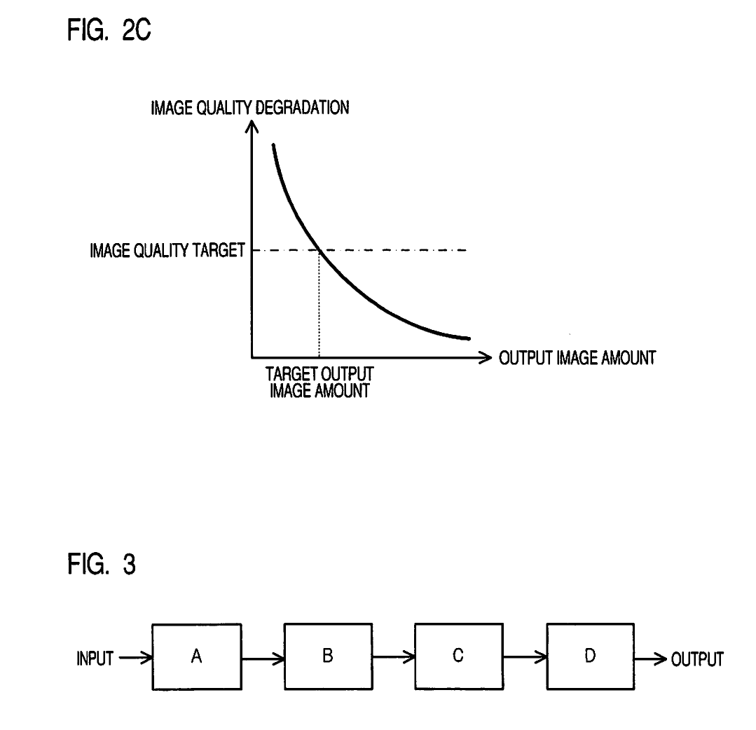

FIG. 3 shows an example of the pipeline in the initial state configured by the pipeline configuration unit 16. As shown in FIG. 3, the pipeline is configured by successively connecting plural processing modules and, in the example shown in FIG. 3, the pipeline is configured by connecting the respective inputs and outputs of the processing modules A, B, C, and D in this order.

In the exemplary embodiment, the pipeline is reconfigured so as to reduce the information amount of the image data by performing, in at least a part of the processing modules constituting the pipeline, the modification of the attribute of image data processed by the processing module. A detailed description will be given below to the function related to the reconfiguration processing of the pipeline.

The modification attribute selection unit 18 selects, among attributes of the image data to be processed, the attribute that allows a reduction in the information amount of the image data when the attribute is modified. The attributes of the image data include “an image size”, “an image format”, “the number of gradations”, “the number of colors”, and the like, and the modification attribute selection unit 18 selects one of the attributes as the attribute to be modified. “The image size” is the size of the image represented by the image data such as, e.g., the number of vertical and horizontal pixels or the like, and “the image format” is a data format such as uncompressed RAW data, bitmap data, compressed JPEG data, GIF data, or the like. “The number of gradations” is the number of steps in density range for each color representing the image data, and “the number of colors” is the number of channels of colors included in the image data.

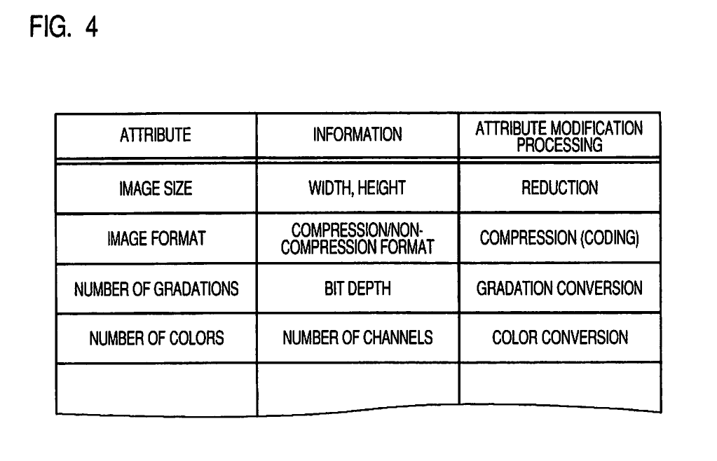

FIG. 4 shows a table in which the attributes of the image data and the modification processing for the attributes are associated with each other. As shown in FIG. 4, the information amount of the image data is reduced by “reducing” “the image size” of the image data, and the information amount of the image data is reduced by “compressing” “the image format” into a format with higher compressibility. Similarly, the information amount of the image data is reduced by performing “a gradation conversion” for reducing “the number of gradations” of the image data, and the information amount of the image data is reduced by performing “a color conversion” for reducing “the number of colors”.

When selecting which attribute to be modified among the attributes of the image data, the modification attribute selection unit 18 may select the attribute which satisfies the image quality target inputted in the initial input unit 14 when the attribute is modified.

The processing module extraction unit 20 extracts, among the processing modules included in the pipeline in the initial state configured by the pipeline configuration unit 16 or/and processing modules having functions equivalent to the functions of the respective processing modules included in the pipeline in the initial state, the processing module capable of processing the image data of which the attribute selected in the modification attribute selection unit 18 is modified. Specifically, the processing module extraction unit 20 successively determines whether or not the image data with the modified attribute can be processed for each of the processing modules included in the pipeline in the initial state. When it is determined that the image data cannot be processed, the processing module extraction unit 20 further determines whether or not there is the processing module capable of processing the image data with the modified attribute among the processing modules each having the function equivalent to the functions of the processing modules. As the result of the determination, when there is the corresponding processing module, the processing module extraction unit 20 extracts the processing module.

For example, in the pipeline constituted by processing modules A to D shown in FIG. 3, when an attribute X of image data is modified to be an attribute Y, assuming that the processing module B can process the attribute Y and, with regard to the processing module D, a processing module D′ having the equivalent function can process the attribute Y, the processing modules B and D′ are extracted by the processing module extraction unit 20. When there are plural extracted processing modules and the extracted modules can be connected with each other by changing the order in which other processing modules are arranged, a sub-pipeline obtained by connecting the processing modules (connected processing element group) may be determined as an extraction target.

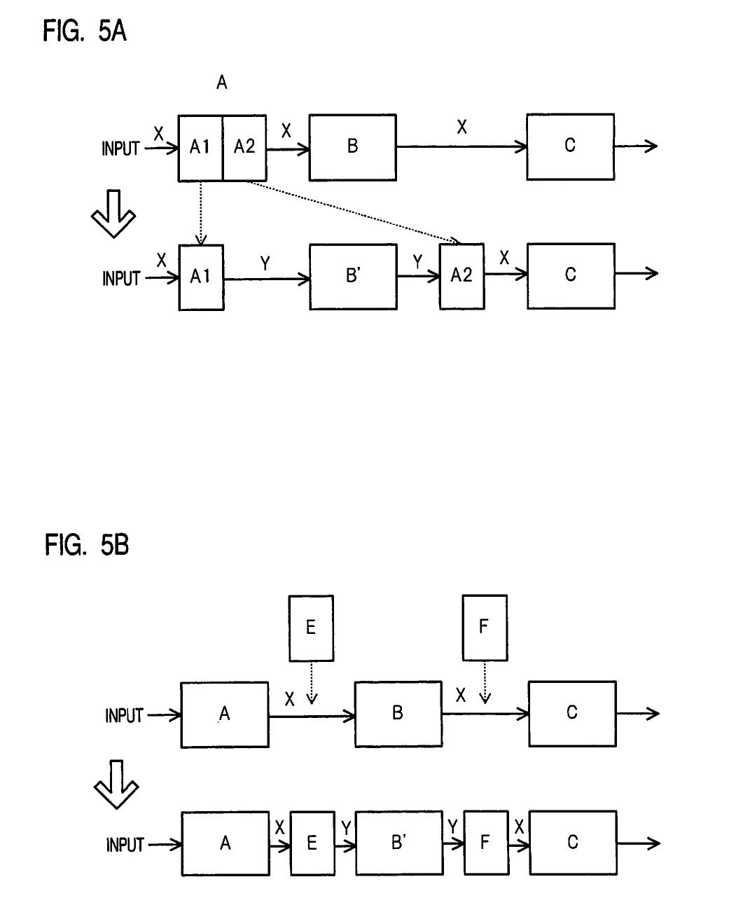

The attribute modification/restoration module placement unit 22 places an attribute modification module for modifying the attribute selected by the modification attribute selection unit 18 and an attribute restoration module for restoring the modified attribute anterior and posterior to the sub-pipeline extracted by the processing module extraction unit 20. As will be described below, there are two methods for placing the attribute modification module and the attribute restoration module which include a method of generating them from the processing module included in the pipeline and placing them and a method of newly adding and placing them. FIG. 5A is an illustrative view related to the first method, while FIG. 5B is an illustrative view related to the second method.

In the first method, as shown in FIG. 5A, when one of the processing modules included in the pipeline (processing module A) is divided into a pair of an attribute modification module A1 and an attribute restoration module A2, the attribute modification module A1 and the attribute restoration module A2 obtained by the dividing are placed anterior and posterior to the processing module B which processes the attribute Y. For example, when the processing module A is assumed to be two-fold enlargement processing, the processing module A may be divided into the processing module A1 for performing ½ compression processing and the processing module A2 for performing four-fold enlargement processing and, when the processing module A is assumed to be JPEG decompression (decoding), the processing module A may be divided into the processing module A1 for performing Huffman decoding and the processing module A2 for performing DCT inverse conversion.

The first method described above is used when the following conditions are satisfied:

(1) the function of the processing module A before the division and the function of the processing modules after the division (A1+A2) are equivalent to each other,

(2) the processing module B in the stage subsequent to the processing module A is capable of processing the attribute Y modified from the attribute X by the processing module A1, or the processing module B can be replaced with a processing module B′ equivalent to the processing module B in terms of the function and capable of processing the attribute Y,

(3) it is possible to interchange the position of the processing module A2 and the position of the processing module B′ in the order of the processing modules.

When the processing module B is capable of processing the attributes X and Y, the processing module B and the processing module B′ may be the same processing module.

When any of the foregoing conditions (1) to (3) is not satisfied so that the first method cannot be used, for example, when there is not the processing module that is divided into the attribute modification module and the attribute restoration module in the pipeline, the attribute modification module and the attribute restoration module may be added to the pipeline by using the second method shown below.

The second method is a method in which an attribute modification module E and an attribute restoration module F are newly inserted anterior and posterior to the sub-pipeline extracted by the processing module extraction unit 20, as shown in FIG. 5B. The second method is used when the following conditions are satisfied:

(1′) there is the processing module extracted by the processing module extraction unit 20 (that is, the processing module included in the pipeline is capable of processing the attribute Y after the modification of the attribute, or there is the processing module equivalent thereto in terms of the function and capable of processing the attribute Y),

(2′) the processing module in the subsequent stage can be replaced with the processing module extracted in (1′).

When the processing module incapable of processing the attribute Y after modification is included in the subsequent stage, the attribute restoration module for restoring the modified attribute is inserted immediately anterior to the processing module. However, in a case which does not apply to the situation described above, it is not necessary to insert the attribute restoration module.

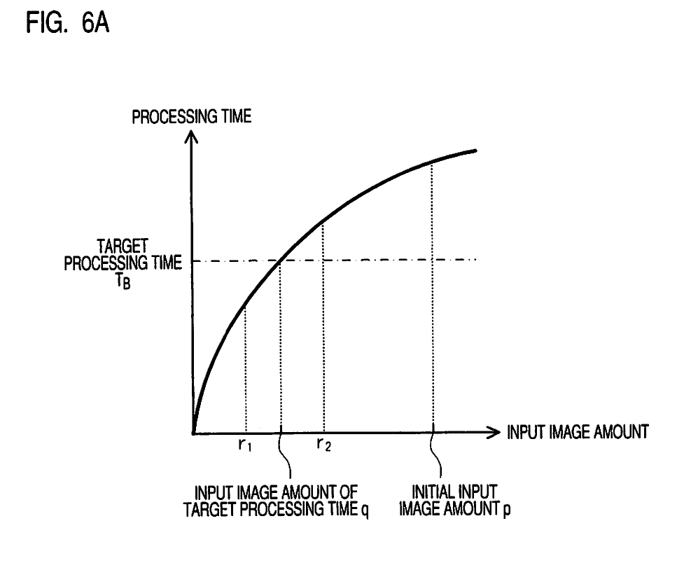

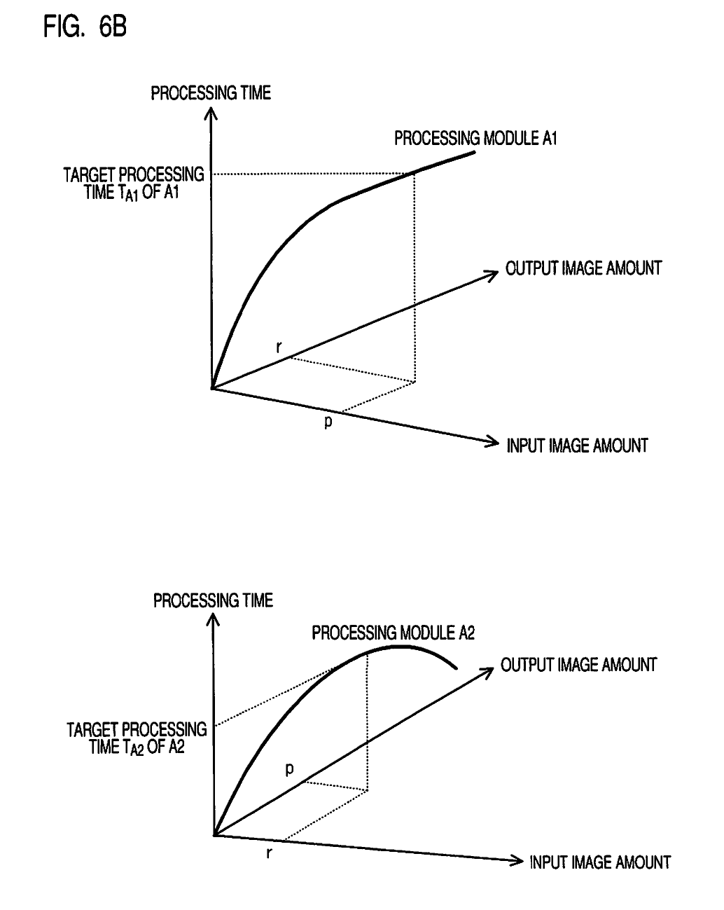

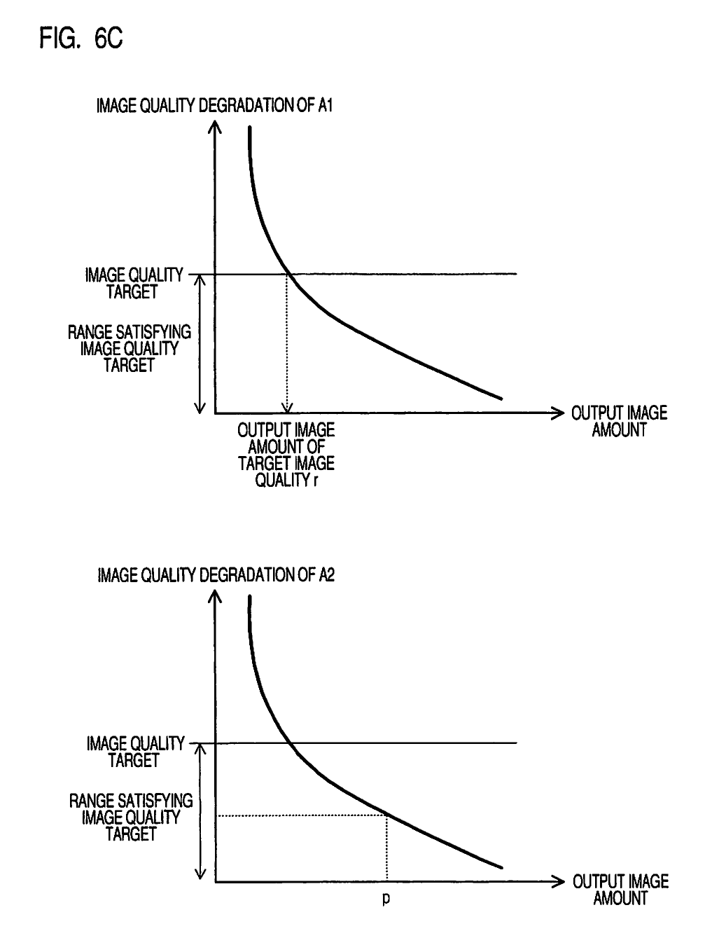

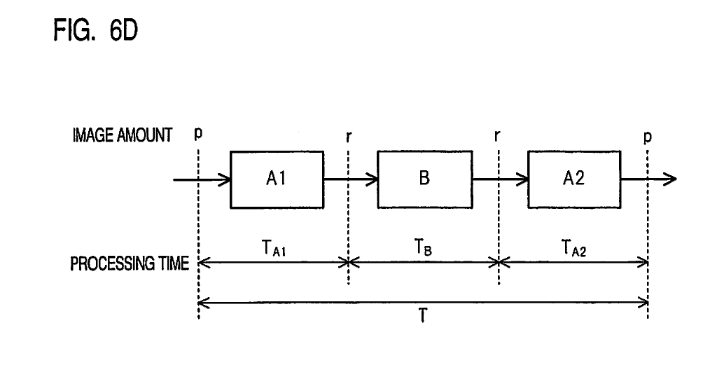

The target attainment determination unit 24 determines whether or not the processing time of the pipeline modified by placing the attribute modification module and the attribute restoration module satisfies a target value inputted in the initial input unit 14. By taking as an example the case where the attribute modification module A1 and the attribute restoration module A2 obtained by dividing the processing module A are placed anterior and posterior to the processing module B which processes the image data of which the attribute is modified, a description will be given to specific processing of the target attainment determination unit 24 with reference to the drawings showing the relation among the input image amount, the output image amount, and the processing time of the respective processing modules in FIGS. 6A and 6B, the relation between the output image amount and the image quality in FIG. 6C, and the target processing time of each of the processing modules in FIG. 6D.

In the example described above, it is assumed that other processing modules are not modified from their states in the pipeline in the initial state for the sake of simplicity. As shown in FIG. 6D, the input image amount of A1 is indicated by p, the output image amount thereof is indicated by r, the input image amount of B is indicated by r, the output image amount thereof is indicated by r, the input image amount of A2 is indicated by r, and the output image amount thereof is indicated by p. In this case, processing time T to be achieved by the sub-pipeline constituted by the processing modules A1, B, and A2 is calculated by subtracting time required for the processing of other processing modules from the target processing time. As shown in FIG. 6C, the output image amount of A2 p is assumed to be in a range satisfying the image quality target (because, otherwise, the pipeline satisfying the requirement can not be configured in the first place).

The target attainment determination unit 24 firstly determines the output image amount of the target image quality of A1 r from the relation between the output image amount of A1 and the image quality degradation shown in FIG. 6C. The output image amount of the target image quality mentioned herein is an image amount which satisfies the image quality target when the image amount outputted by A1 is not less than the target output image amount. Next, as shown in FIG. 6B, on determining the processing time of A1 T_{A1} and the processing time of A2 T_{A2}, the target attainment determination unit 24 calculates the target processing time of B T_{B} by subtracting (T_{A1}+T_{A2}) from the allocated processing time T (T_{B}=T−(T_{A1}+T_{A2})). Then, the target attainment determination unit 24 determines the target input image amount q inputted to the processing module B based on the processing time T_{B} allocated to the processing module B and the information on the relation between the input image amount of the processing module B and the processing time thereof shown in FIG. 6A. The target input image amount mentioned herein is an image amount which satisfies the processing time allocated to the processing module B when the image amount inputted to the processing module B is not more than the target input image amount.

When the thus determined input image amount of the target image quality r is not more than the input image amount of the target processing time q (q≧r) (r₁ in FIG. 6A), the target attainment determination unit 24 determines that the target is attained and, when r is more than q (q<r) (r₂ in FIG. 6A), the target attainment determination unit 24 determines that the target is not attained. When the target attainment determination unit 24 determines that the target is not attained and the attribute that can be modified is present, the selection of the attribute may be performed back in the modification attribute selection unit 18 and the modification of the pipeline may be continued.

On the other hand, when the target attainment determination unit 24 determines that the target is attained, the pipeline reconfiguration unit 26 reconfigures the pipeline using the group of the processing modules which have served as the determination target and ends the processing. A structure may be adopted in which, after the reconfiguration of the pipeline, the reconfigured pipeline processes the image data.

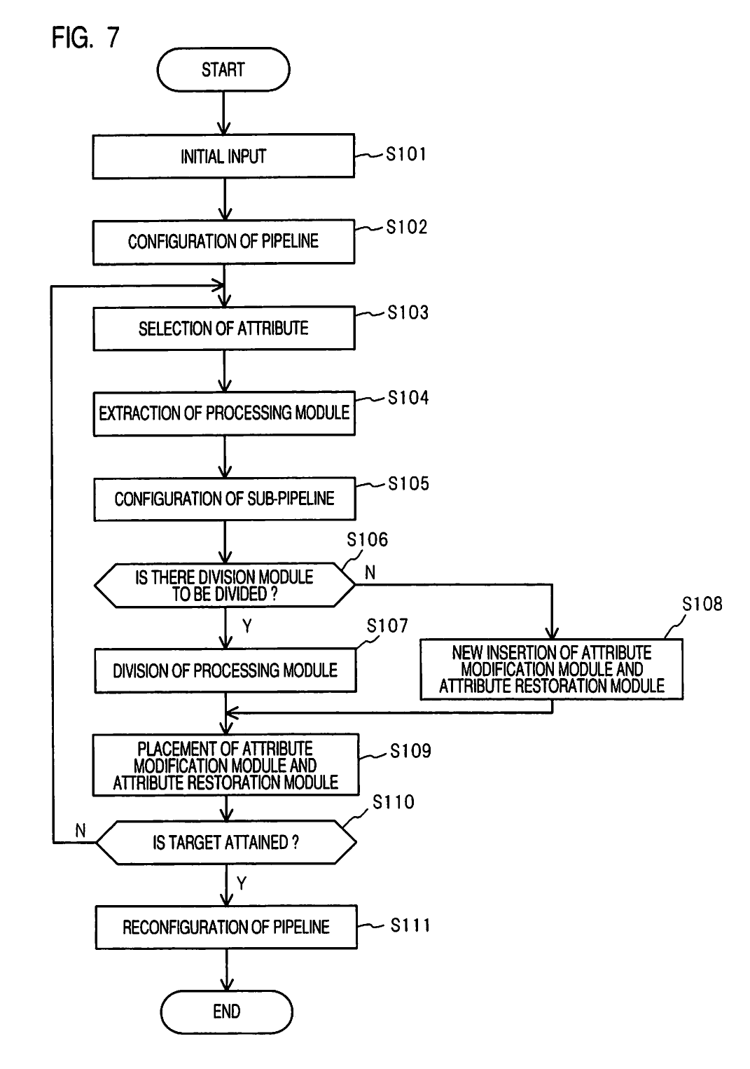

Next, a description will be given to the flow of the reconfiguration processing of the pipeline by the information processing apparatus 10 with reference to the flow chart shown in FIG. 7.

As shown in FIG. 7, the information processing apparatus 10 receives initial inputs such as the image data, the content of the image processing, the cost targets (the processing time target and the output image quality target), and the like (S101), and configures the pipeline (in the initial state) for processing the image data based on the received information (S102).

Next, the information processing apparatus 10 selects, among the attributes of the image data, the attribute which allows a reduction in the information amount of the image data when the attribute is modified (S103), and extracts the processing module capable of processing when the selected attribute is modified from among the processing modules included in the pipeline and processing modules which are equivalent to the processing modules included in the pipeline in terms of the function (S104).

The information processing apparatus 10 performs the change of the order of the processing modules constituting the pipeline so as to connect the extracted processing module described above to configure the sub-pipeline (connected processing element group) obtained by connecting the processing module capable of processing the modified attribute (S105).

The information processing apparatus 10 determines whether or not there is a processing module (division module) that is divided into a pair of the attribute modification module and the attribute restoration module among the processing modules in the pipeline other than the configured sub-pipeline described above (S106). When the information processing apparatus 10 determines that “there is the processing module” (S106: Y), the information processing apparatus 10 divides the corresponding processing module (S107) and, when the information processing apparatus 10 determines that “there is not the processing module” (S106: N), the information processing apparatus 10 newly inserts the attribute modification module and the attribute restoration module into the pipeline (S108).

Next, the information processing apparatus 10 places the attribute modification module and the attribute restoration module anterior and posterior to the sub-pipeline (S109), and determines whether or not the cost targets are attained by the new pipeline in which the attribute modification module and the like are placed (S110). When the information processing apparatus 10 determines that the cost targets are not attained (S110: N), the flow returns to S103. When the attribute to be modified which can be selected is present, the information processing apparatus 10 newly selects the attribute and repeats the processing subsequent thereto. On the other hand, when the information processing apparatus 10 determines that the cost targets are attained (S110: Y), the information processing apparatus 10 reconfigures the pipeline using the group of the processing modules which have served as the determination target (S111) and ends the processing.

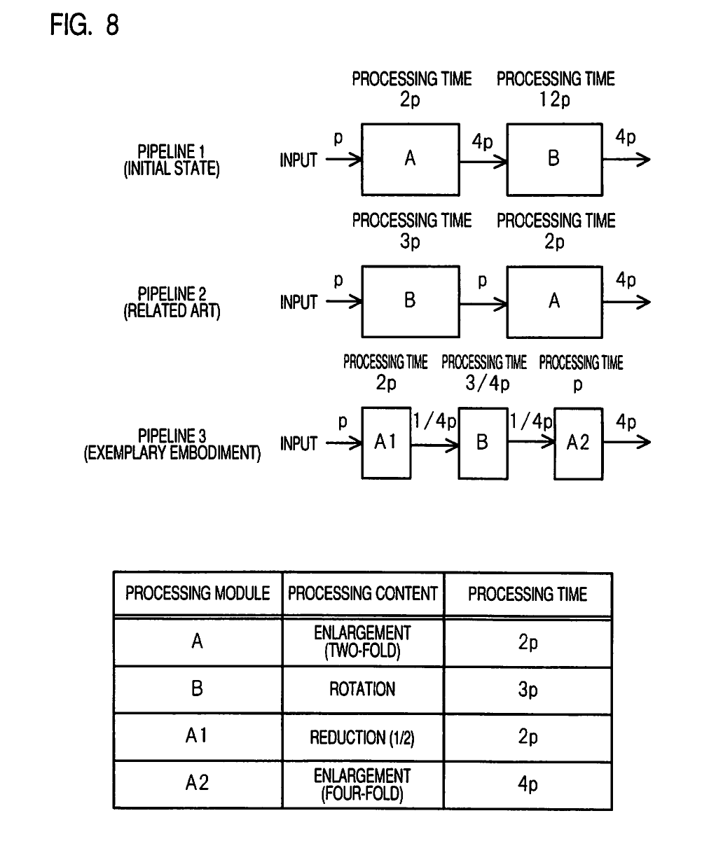

When the pipeline constituted by the processing module A (two-fold enlargement) and the processing module B (rotation) shown in FIG. 8 is processed with the target processing time 4p, because the processing time of the processing module A (two-fold enlargement) with respect to a unit data amount p is 2p, and the processing time of the processing module B (rotation) is 3p, the processing time in a pipeline in the initial state (1) is 2p+3·(4p)=14p, and the processing time therefore does not satisfy the target processing time that is not more than 4p. In addition, even when a pipeline (2) in a related art is configured by simply interchanging the processing module A and the processing module B, the processing time is 3p+2p=5p and does not satisfy the target processing time that is not more than 4p.

By contrast, in accordance with the information processing apparatus 10 of the exemplary embodiment, because the processing time of the attribute modification module A1 (½ reduction) with respect to the unit data amount p is 2p, and the processing time of the attribute restoration module A2 (four-fold enlargement) is 4p, by dividing the processing module A into the attribute modification module A1 (½ reduction) and the attribute restoration module A2 (four-fold enlargement), and reconfiguring the pipeline of A1, B, and A2 in this order, the processing time is 2p+3(¼p)+4(¼p)=2p+¾p+p=3.75p, and the processing time accordingly satisfies the target processing time that is not more than 4p.

The present invention is not limited to the above-described embodiment. For example, although the information processing apparatus 10 according to the above-described embodiment configures and acquires the pipeline in the initial state, it goes without saying that the information processing apparatus 10 may acquire the pipeline configured by another apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquiring unit that acquires a processing element group configured by successively connecting a plurality of processing elements for processing information, the information including a plurality of attributes;
a selection unit that selects, among the attributes, an attribute that allows a reduction in an information amount of the information when the attribute is modified;
an extraction unit that extracts, among the processing element group and processing elements that are functional equivalents of each of the processing elements, a processing element capable of processing the information of which the selected attribute is modified; and
a reconfiguration unit that places an attribute modification element anterior to the extracted processing element to reconfigure the processing element group, the attribute modification element for modifying the selected attribute, the extracted processing element placed alone or in connected relation.

2. The information processing apparatus according to claim 1, wherein the reconfiguration unit further places an attribute restoration element for restoring the modified attribute posterior to the extracted processing element placed alone or in connected relation.

3. The information processing apparatus according to claim 2, further comprising:
a division unit that selects one of the processing elements included in the processing element group and divides the selected one into a set of the attribute modification element and the attribute restoration element.

4. The information processing apparatus according to claim 2, wherein the reconfiguration unit newly adds the attribute modification element and the attribute restoration element to the processing element group.

5. The information processing apparatus of claim 1, further comprising:
a target setting unit that sets a target of a resource required for processing the information so as to acquire output information with a quality that is not lower than a predetermined quality, wherein
the selection unit selects the attribute so as to satisfy the target.

6. The information processing apparatus according to claim 2, further comprising:
a target setting unit that sets a target of a resource required for processing the information so as to acquire output information with a quality that is not lower than a predetermined quality, wherein
the selection unit selects the attribute so as to satisfy the target.

7. The information processing apparatus according to claim 3, further comprising:
a target setting unit that sets a target of a resource required for processing the information so as to acquire output information with a quality that is not lower than a predetermined quality, wherein
the selection unit selects the attribute so as to satisfy the target.

8. The information processing apparatus according to claim 4, further comprising:
a target setting unit that sets a target of a resource required for processing the information so as to acquire output information with a quality that is not lower than a predetermined quality, wherein
the selection unit selects the attribute so as to satisfy the target.

9. The information processing apparatus according to claim 1, further comprising:
a unit that connects the extracted processing element by changing an order in the processing element group.

10. The information processing apparatus according to claim 2, further comprising:
a unit that connects the extracted processing element by changing an order in the processing element group.

11. The information processing apparatus according to claim 3, further comprising:
a unit that connects the extracted processing element by changing an order in the processing element group.

12. The information processing apparatus according to claim 4, further comprising:
a unit that connects the extracted processing element by changing an order in the processing element group.

13. The information processing apparatus according to claim 5, further comprising:
a unit that connects the extracted processing element by changing an order in the processing element group.

14. The information processing apparatus according to claim 6, further comprising:
a unit that connects the extracted processing element by changing an order in the processing element group.

15. The information processing apparatus according to claim 7, further comprising:
a unit that connects the extracted processing element by changing an order in the processing element group.

16. The information processing apparatus according to claim 8, further comprising:
a unit that connects the extracted processing element by changing an order in the processing element group.

17. The information processing apparatus according to claim 1, wherein the information includes image information and the attributes include at least one of an image size, an image format, the number of gradations, and the number of colors of the image information.

18. An information processing method comprising:
acquiring a processing element group configured by successively connecting a plurality of processing elements for processing information, the information including a plurality of attributes;
selecting, among the attributes, an attribute that allows a reduction in an information amount of the information when the attribute is modified;
extracting, among the processing element group and processing elements that are functional equivalents of each of the processing elements, a processing element capable of processing the information of which the selected attribute is modified; and
placing an attribute modification element anterior to the extracted processing element to reconfigure the processing element group, the attribute modification element for modifying the selected attribute, the extracted processing element placed alone or in connected relation.

19. A computer readable medium storing a program that causes a computer to execute information processing, the information processing comprising:
acquiring a processing element group configured by successively connecting a plurality of processing elements for processing information, the information including a plurality of attributes;
selecting, among the attributes, an attribute that allows a reduction in an information amount of the information when the attribute is modified;
extracting, among the processing element group and processing elements that are functional equivalents of each of the processing elements, a processing element capable of processing the information of which the selected attribute is modified; and
placing an attribute modification element anterior to the extracted processing element to reconfigure the processing element group, the attribute modification element for modifying the selected attribute, the extracted processing element placed alone or in connected relation.
